(19) United States
(12) Patent Application Publication
(10) Pub. No.: US 2006/0208243 A1
(43) Pub. Date: Sep. 21, 2006

(54) Staple removing bit especially for upholstery

(76) Inventor: Danny Wayne Foster, Fairbanks, AK (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/082,647

(22) Filed: Mar. 17, 2005

(51) Int. Cl. B25C 11/00

(52) U.S. Cl. 254/28

(57) ABSTRACT

A staple removing tool comprises a shaft having a working end at which opposed sloped surfaces are formed, such that shaft, in side elevation, the working end of the shaft substantially comes to a pointed end. A notch is formed in the forward end of the tool, and a slot extends rearwardly from the apex of the notch. The tool is rotated to remove staples from furniture and can be adapted to be received in an electric drill or screwdriver.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention relates to staple removing tools, and in particular, to a staple removing bit that can be used with an electric screwdriver, drill or the like, to remove staples from furniture when reupholstering.

As is known, in upholstered furniture, the furniture batting and the covering are often held in place by means of staples. When the furniture is reupholstered, all the staples must be removed. Staple removal is a repetitive, difficult and time consuming task. Numerous tools have been developed to aid in removing staples from furniture. However, most of these tools are manual and hence require repetitive motions by the upholsterer. Further, in some instances, two tools are required to remove the staples.

### BRIEF SUMMARY OF THE INVENTION

Briefly stated, an illustrative staple removing tool of the present invention comprises a shaft having a working end at which opposed sloped surfaces are formed, such that the shaft, in side elevation, the working end of the shaft substantially comes to a pointed end.

A generally V-shaped notch is formed at the working end. The notch is formed in the plane of the sloped surfaces, such that the notch extends between the sloped surfaces. The notch comprises opposed and facing inner surfaces slope inwardly toward each other to form a base of the notch. The notch surfaces increase in width from the end of the shaft to the notch's base. The notch surfaces form an angle with each other of about 10° to about 160°. Illustratively, the surfaces for an angle of about 90°. In addition, the notch surfaces form an angle of about 90° with the sloped surfaces. For a notch having a width of approximately ¼″ at the end of the notch, the notch has a depth of about 0.1″ from the forward end of the notch to the base of the notch.

Lastly, the tool includes a slot extending axially rearwardly from the apex of the notch. The slot can have a length of about ⅛″ to about ½″ but may need to be longer in some applications.

### BRIEF DESCRIPTION OF THE SEVERAL VIEWS OF THE DRAWINGS

FIG. 1 is a perspective view of an illustrative staple removing tool of the present invention;

FIG. 2 is a side plan view of the tool;

FIG. 3 is a plan view of the tool taken 90° relative to the view of FIG. 2;

FIG. 4 is an end plan view of the tool, enlarged relative to the drawings of FIGS. 2 and 3.

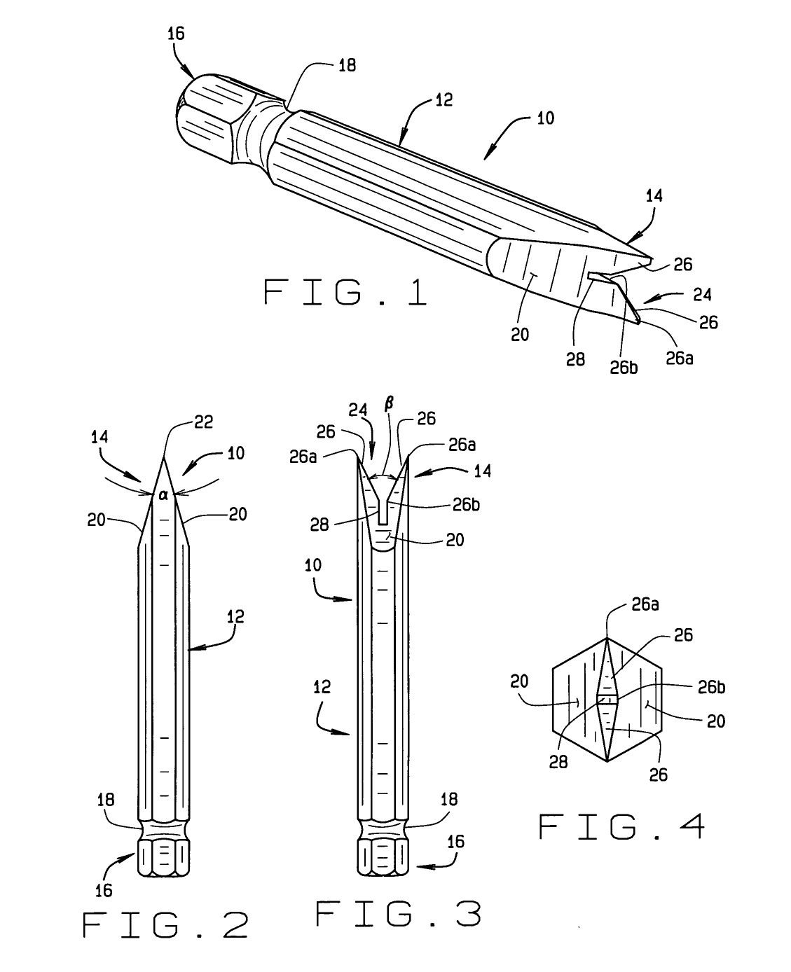

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes what I presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting. Although the invention is described for use in removing staples from upholstered furniture, it can be used for other applications as well where staples need to be removed. For example, the invention can be used for staple removal in cardboard boxes, construction materials, electrical application, fencing, carpet removal, etc.

An illustrative embodiment of a staple removing tool or bit 10 is shown generally in the Figures. The tool 10 includes a shaft 12 having a first end 14 and a second end 16. The shaft 12 is shown to be hexagonal so that the bit 10 can be received in a power driven handpiece, such as an electric drill or screwdriver. The bit 10 can also be received in a manual handpiece adapted to receive different bits. Preferably, the shaft 12 is about ¼″ to about ⅜″ in diameter, so that it can be received in most commercially available drills, bit-receiving screwdrivers and the like. A circumferential groove 18 is formed near the second end 16 of the bit 10 to enable the chuck of a drill to engage the bit 10.

The first end 14 is the working end of the bit or tool 10. The working end includes opposed sloped surfaces 20 which meet at a tip 22 having a width substantially less than the diameter of the shaft 12. Thus, the first end 14 defines a triangle, which may have a very small flat surface at its end. Hence, the tip 22 is substantially pointed. The angle α defined by the sloped surfaces 20 can be as about 10°. As can be appreciated, a sharp angle will facilitate insertion of the forward end of the bit 10 between a staple and the surface in which the staple is inserted easier. However, this angle can vary depending on the application for which the bit will be used.

A V-notch 24 is formed at the tip 22. The notch 24 is formed in the plane of the surfaces 20. The notch 24 includes inner edges or surfaces 26 which form an angle of about 90° with the sloped surfaces 20. The notch surfaces 26 extend rearwardly and inwardly from a position 26a substantially adjacent the outer edge of the bit toward a base 26b. Hence, the forward ends 26a of the notch define spaced apart points, as best seen in FIG. 3. Because the notch 24 is formed in the plane of the surfaces 20, the edge surfaces 26 of the notch increase in width from their forward ends or points 26a to the notch base 26b. The surfaces 26 form an angle β of about 10° to about 160°. The depth of the V-notch 24 will vary with the angle formed at 28b in relation to the distance between points 26a as needed in the best performance for removal of the staple. In one illustrative example, for a ¼″ bit, with an angle β of about 90°, the axial depth of the V-notch (from the tip end 26a to the notch 26b) is about 0.11″ (about 3 mm), the length of the surfaces 26 are about 0.16″ to about 0.20″ (about 4-5 mm), and the width of the notch between the points 26a is about ¼″. These dimensions can vary depending on the size of the bit used and the angle β defined by the notch surfaces 26.

A slot 28 extends rearwardly from the notch's apex 26b. The slot 28 is sized to receive the staple being removed. The slot 28 will be at least about ⅛″ to about ½″ long. However, its length can be longer if necessary to receive a particular type of staple.

In operation, the pointed end 26a if the bit 10 is inserted under staple (i.e., between the staple and the wood of the furniture being reupholstered). The bit is then rotated. As the bit is rotated, the staple is wound about the bit and is automatically pulled from the furniture. If for some reason the staple does not come completely out in the first rotation of the bit, the staple is inserted into slot 28 and the bit is rotated again to remove the balance of the staple. Using the bit, the staple is typically removed from the furniture with ¾″ of a rotation to one complete rotation of the bit, depending on the staple width and the length of the legs.

As noted above, the bit can be received in an electric drill or screwdriver (which can be corded or cordless). I have found that even cordless screwdrivers, when set to a high torque and low speed setting effectively remove the staple from the furniture. As can be appreciated, when an electric screwdriver or drill is used to rotate the bit, there is very little action required by the furniture refinisher, making removal of staples from the furniture quick and easy.

As various changes could be made in the above construction without departing from the scope of the invention, it is intended that all matter contained in the above description or shown in the accompanying drawings shall be interpreted as illustrative and not in a limiting sense. Although the tool 10 is shown and described as a bit which can be removably received in electric drills, screwdrivers and the like, the tool could also be formed as a single use instrument. That is, the shaft 12 could be an elongate shaft having a handle formed at the end opposite the first end 14. The shaft 12 could be rounded or have any other multi-faceted configuration, as may be desired. The circumferential groove 18 can also be omitted. Although the notch is shown to be V-shaped, it could also be U-shaped. These examples are merely illustrative.

1. A staple removing tool comprising:
a shaft having a working end; said shaft including opposed sloped surfaces at said working end, such that shaft, in side elevation, substantially comes to a pointed end;
a notch at said working end; said notch being formed in the plane of said sloped surfaces and having a forward end and a base; said notch comprising opposed and facing inner surfaces; said notch surfaces increasing in width from the forward end of said notch to said notch base; and
a slot extending axially rearwardly from said notch base.

2. The staple removing tool of claim 1 wherein said shaft is faceted to be removably received by a driver, such as an electric screwdriver or a drill.

3. The staple removing tool of claim 1 wherein said notch surfaces form an angle with each other of about 10° to about 160°.

4. The staple removing tool of claim 3 wherein said notch surfaces form an angle with each other of about 90°.

5. The staple removing tool of claim 1 wherein said notch surfaces form an angle of about 90° with the sloped surfaces.

6. The staple removing tool of claim 1 wherein said slot has a length of is about ⅛″ to about ½″.

7. The staple removing tool of claim 1 wherein said notch has a depth of about 0.1″.

8. A staple removing tool comprising:
a shaft having a working end; said shaft including opposed sloped surfaces at said working end, such that shaft, in side elevation, substantially comes to a pointed end;
a notch at said working end; said notch being formed in the plane of said sloped surfaces and having a forward end and a base; said notch comprising opposed and facing inner surfaces; said notch surfaces increasing in width from the forward end of said notch to said notch base; said notch surfaces defining an angle of about 90° with said sloped surfaces and an angle of about 10° to about 160° with each other; and
a slot extending axially rearwardly from said notch base.

9. The staple removing tool of claim 8 wherein said notch surfaces form an angle with each other of about 90°.

10. The staple removing tool of claim 8 wherein said slot has a length of about ⅛″ to about ½″.
